(19) United States
(12) Patent Application Publication
(10) Pub. No.: US 2026/0189465 A1
(43) Pub. Date: Jul. 2, 2026

(54) OPTIMIZING IN-BUILDING NETWORK COVERAGE THROUGH GEOSPATIAL ANALYSIS

(71) Applicant: T-Mobile USA, Inc., Bellevue, WA (US)

(72) Inventors: Sridhar Bethamsetty, Frisco, TX (US); Tole Bewa, Black Diamond, WA (US); Gaurav Khaitan, Newcastle, WA (US); Pankaj Saxena, Sammamish, WA (US)

(21) Appl. No.: 19/003,854

(22) Filed: Dec. 27, 2024

(51) Int. Cl. H04L 41/14; H04L 43/08

(52) U.S. Cl. CPC H04L 41/145; H04L 43/08

(57) ABSTRACT

Disclosed here are methods, systems, and apparatuses for optimizing in-building network coverage through aggregation of usage data, network data, and other performance metrics and geospatial analysis employed to map network coverage data onto a geographic grid, facilitating spatial visualization of performance. The network coverage data is mapped to the buildings data to create a spatial visualization. A model is then applied to the network coverage data and the spatial visualization to identify buildings with a network coverage score below a threshold, and an appropriate action is performed based on the identification.

### BACKGROUND

It is crucial for wireless communications systems to provide reliable in-building wireless coverage for critical services such as voice calls, text messages, and high-speed internet. In light of the growing dependence on mobile devices and increasing number of mobile subscribers around the world, in-building wireless technology has improved substantially over the last decade. Some of the technologies used for in-building wireless coverage include small cells and distributed antenna systems, as well as Internet of Things (IoT) technology that provides unimpeded communication and automation within buildings. Improving in-building wireless coverage can be challenging due to various factors such as building materials, distance from cell towers, and interference from other electronic devices.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a drawing that illustrates a method for optimizing in-building network coverage through aggregation of performance data and geospatial analysis with aspects of the present technology.

FIG. 4 illustrates an example model implementation platform implementing the model applied by the network in accordance with some implementations of the present technology.

FIG. 5 is a drawing that illustrates an example process performed by the network upon receiving a query regarding in-building network coverage of a given location in accordance with aspects of the present technology.

FIG. 6 is a flow diagram that illustrates an example process in accordance with aspects of the present technology.

FIG. 7 is a diagram that illustrates data tables aggregated by the network in accordance with aspects of the present technology.

FIG. 8 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

With proliferation of mobile devices and growing demand for high-speed connectivity, performance of wireless networks within indoor environments has become a critical factor influencing subscriber satisfaction and retention. Reliable in-building network coverage is essential in order to enable subscribers to be in touch and access critical services. Despite advancements in technology, there are several shortcomings associated with in-building network coverage provided by network providers today. For example, modern buildings often use materials such as concrete, steel, and low-emissivity glass, which can significantly interfere with wireless signals, preventing the wireless signals from penetrating and providing adequate in-building network coverage. Additionally, networks in buildings with a high density of users, such as office buildings, shopping malls, and stadiums, can become congested, leading to slower data transmission speeds and dropped calls. In some cases, network providers may lack sufficient infrastructure to handle a high volume of traffic in densely populated areas, leading to poor in-building network coverage for the subscribers involved.

To address the shortcomings of in-building network coverage provided by network providers today, introduced here are methods, systems, and apparatuses for optimizing in-building network coverage through aggregation of usage data, network data, and other performance metrics and geospatial analysis employed to map the aggregated data onto a geographic grid, facilitating spatial visualization of performance. The technology, also referred to as in-building coverage and capacity analytics (iBCCA), is developed as a robust analytics platform tailored to assess the coverage and capacity performance of a network provider's networks within buildings. In some implementations, a network is configured to harmonize crowdsourced user data from public databases along with network data to enable a comprehensive analysis of performance metrics and network coverage. The comprehensive analysis can be mapped to buildings using a mapping application programming interface (API) and geospatial analysis. Buildings with a network coverage score below a threshold can be identified through a spatial visualization of the comprehensive analysis of performance metrics and network coverage, and adequate action can be performed based on the identification.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

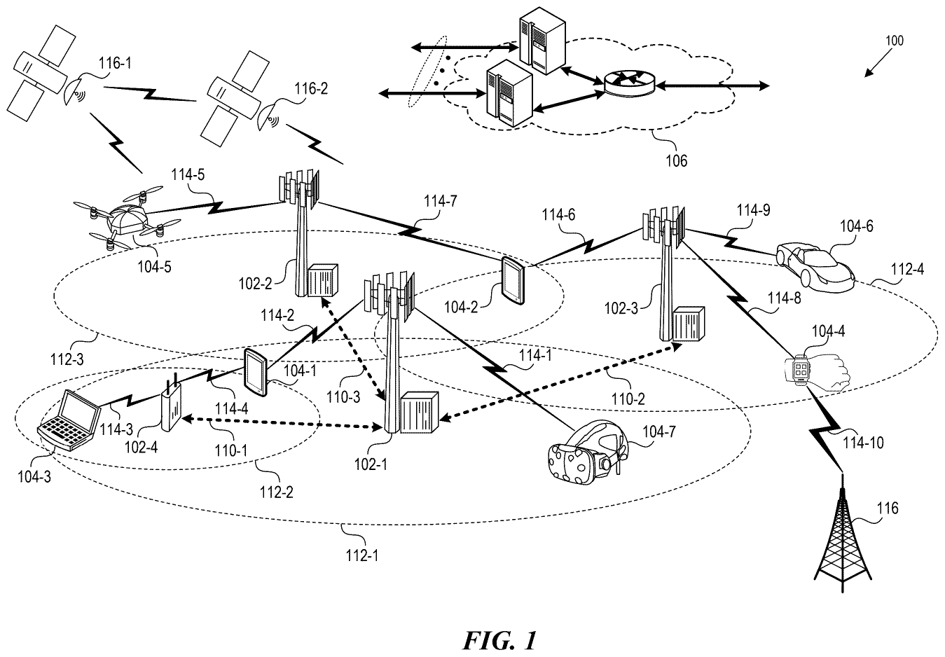

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 gigahertz (GHz) or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., IoT, mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-10 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The DL transmissions can also be called forward link transmissions while the UL transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) (e.g., using unpaired spectrum resources) operation. In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultra-high quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and core architecture to achieve Control and User Plane Separation (CUPS) and achieve extremely low user plane latency. In yet another example of 6G, the network 100 can implement a converged Wi-Fi and core architecture to increase and improve indoor coverage.

### 5G Core Network Functions

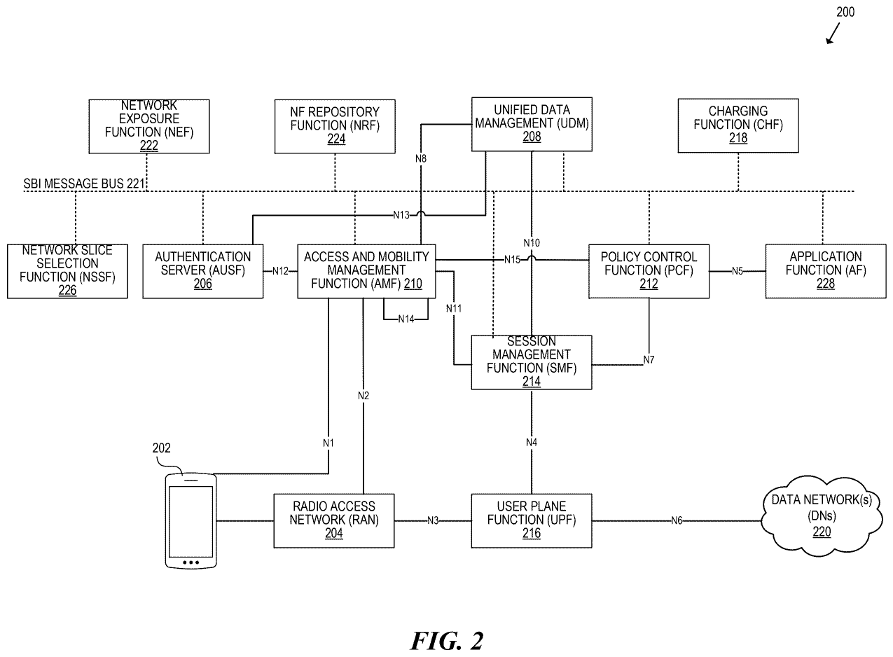

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility Management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Optimizing in-Building Network Coverage Through Aggregation of Performance Data and Geospatial Analysis

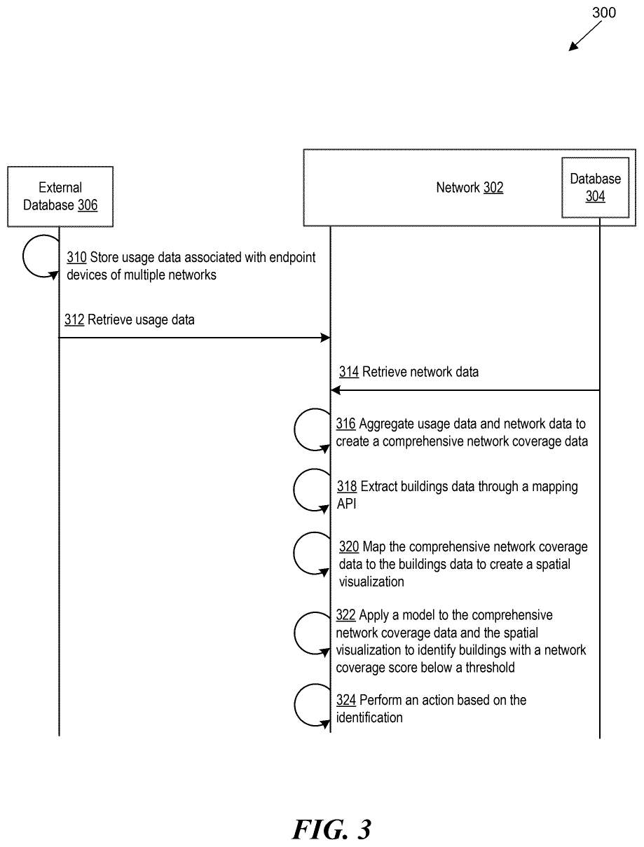

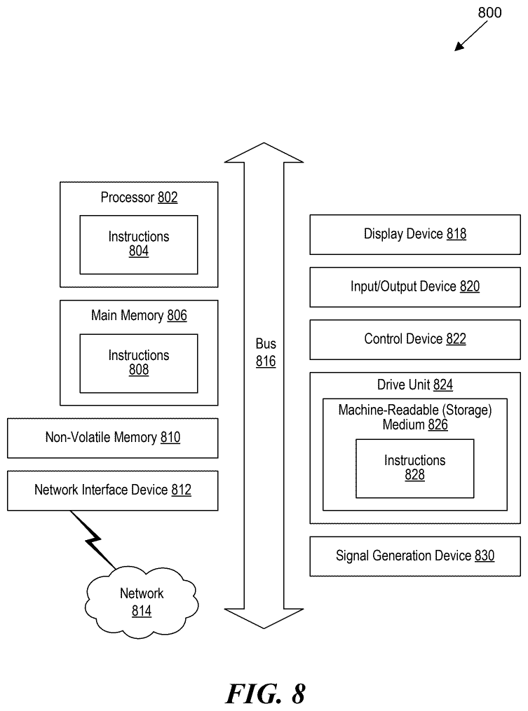

FIG. 3 is a drawing that illustrates a method for optimizing in-building network coverage through aggregation of performance data and geospatial analysis with aspects of the present technology. A network 302, database 304, and external database 306 can be implemented using processor 802 and instructions 808 programmed in the memory 806 illustrated and described in more detail with reference to FIG. 8. Although illustrated in a particular configuration, one or more operations of the method 300 may be omitted, repeated, or reorganized. Additionally, the method 300 may include other operations not illustrated in FIG. 3, for example, operations detailed in one or more other methods described herein.

As illustrated, the network 302 is capable of performing various NFs as well as communicating with external networks and databases such as the external database 306 to send and retrieve data. At 310, the external database 306 is configured to store usage data associated with endpoint devices of multiple networks. The usage data stored in the external database 306 is collected by analysis platforms such as Ookla and Umlaut. The usage data crowdsourced by the analysis platforms can include internet connection performance metrics such as download speed, upload speed, latency, jitter, packet loss, network type, and/or location data associated with a connection, as well as mobile network performance metrics such as network coverage, signal strength, data throughput, call performance, application performance, and/or user experience metrics. The usage data can also include Quality of Service (QoS) scores captured by endpoint devices subscribed to the analysis platforms. To ensure privacy, the usage data collected and stored in the external database 306 is anonymized and excludes personal identifying information of the endpoint devices. The usage data includes multiple datapoints each representing usage metrics captured by the endpoint devices subscribed to the analysis platforms. In some implementations, the usage data collected and stored is for endpoint devices of the network 302 only and does not include usage data for endpoint devices of other networks.

At 312, the network 302 retrieves the usage data from the external database 306. In some implementations, the network 302 is configured to retrieve the usage data associated with endpoint devices of the network 302. In other implementations, the network 302 is configured to retrieve the usage data associated with endpoint devices of the network 302 and other networks.

At 314, the network 302 retrieves network data from the database 304. The network data is data specific to the network 302 and can include network performance metrics such as network capacity, network density, network utilization, network availability, network topology data, and/or traffic analysis associated with the network 302. The network data can also include other information such as radio and backhaul capacity as well as sales data.

At 316, the network 302 aggregates the usage data retrieved from the external database 306 and the network data retrieved from the database 304 to create a comprehensive network coverage data. The aggregation can be performed by first identifying features common to the usage data and the network data, such as location information identifying latitude and longitude associated with a datapoint. The usage data and the network data can be aligned using the common identifying feature and combined into a single dataset. The aggregation can also be performed using database joins, data warehousing, or extract, transform, load (ETL) procedures. In some implementations, the network 302 performs data cleaning on the comprehensive network coverage data to remove duplicate entries, address missing datapoints via imputations or removal of incomplete records, convert the data into a standardized format, and/or remove outliers or erroneous entries.

At 318, the network 302 extracts buildings data from a mapping API. Examples of mapping API that can provide buildings data include Google Maps API, OpenStreetMap API, Mapbox API, and Here API. After obtaining API access and retrieving buildings data in response to an API request, the network 302 can employ visualization tools to visualize the buildings data.

At 320, the network 302 maps the comprehensive network coverage data to the buildings data to aggregate the data and create a spatial visualization of the comprehensive network coverage data. Spatial aggregation of the buildings data includes associating datapoints of the network coverage data with corresponding buildings of the buildings data. In some implementations, the network 302 utilizes feature engineering to capture additional metrics that are relevant for spatial aggregation of the buildings data. In other implementations, additional layers of data are aggregated along with the usage data and the network data. The additional layers can include data of businesses and locations of businesses extracted from Dun and Bradstreet API, which can be utilized along with the usage data and the network data to identify correlations between the network coverage data and the locations of businesses.

The spatial visualization of the comprehensive network coverage data can include multiple polygons each representing a building, and wherein each polygon is associated with multiple datapoints captured by endpoint devices within the representative building. The size of the polygons can correspond to the size of actual buildings. In some implementations, the multiple polygons are two-dimensional visualizations of building layouts. In other implementations, the network 302 is configured to construct three-dimensional visualizations using layers of data.

In some implementations, after the network 302 creates the spatial visualization of the comprehensive network coverage data, there may be overlaps among the multiple polygons. The network 302 can perform further geospatial analysis to remove or modify portions of the spatial visualization for accurate mapping of the comprehensive network coverage data. Such disambiguation of data can be performed automatically through application of a model by the network 302. The model can be trained using different types of datasets including the comprehensive network coverage data and the buildings data to identify mapping errors, polygon overlaps, and other issues.

In other implementations, the network 302 can be further configured to generate, within each polygon, subdivisions of datapoints, wherein each subdivision includes datapoints with common usage metrics. For example, the network 302 may identify that a polygon representing a shopping mall has two subdivisions of datapoints, a first subdivision associated with optimal signal strength, signal strength, and connection speed and a second subdivision associated with reports of frequent performance bottlenecks and network outages. Based on the identification of the subdivisions, the network 302 can adopt the subdivisions in the spatial visualization for more accurate reflections of varying network coverage metrics within the polygon.

At 322, based on the comprehensive network coverage data and the spatial visualization, the network 302 applies a model to evaluate network coverage of buildings by assigning network coverage scores to identified buildings. The model can be further utilized to identify buildings with a network coverage score below a threshold. Various factors may be considered when calculating the network coverage scores, such as signal quality, signal strength, throughput, and history of performance bottlenecks reported. The model can be a rule-based model or a trainer machine learning (ML) model.

A “model,” as used herein, can refer to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include neural networks, support vector machines, decision trees, Parzen windows, Bayes clustering, reinforcement learning, probability distributions, decision tree forests, and others. Models can be configured for various situations, data types, sources, and output formats.

One or more of the machine learning models described herein can be trained with supervised learning, where the training data includes the comprehensive network coverage data and the buildings data as input and a desired output, such as a network coverage score associated with a building. Additionally, after outputting network coverage scores of the buildings, the network 302 is further configured to define a threshold network coverage score. Buildings with threshold network coverage scores below the threshold can be identified and, in some implementations, highlighted by the network 302.

At 324, the network 302 performs an action based on the identification of buildings with a network coverage score below the threshold. The action can include generating a list of actionable items to improve network performance, generating an internal alert within the network 302 to notify relevant administrators of the network to take actions to improve network performance and/or updating the spatial visualization to highlight the identified buildings. The action can also include generating a report of the network coverage of the identified buildings, wherein the report includes usage data and network data of multiple datapoints captured within the buildings. In some implementations, the network 302 is configured to receive network coverage data of other networks within the identified buildings for comparison. Based on the comparison, the network 302 may generate a report comparing the network coverage data of multiple networks to gauge the network 302's performance and coverage among its competitors within the identified buildings.

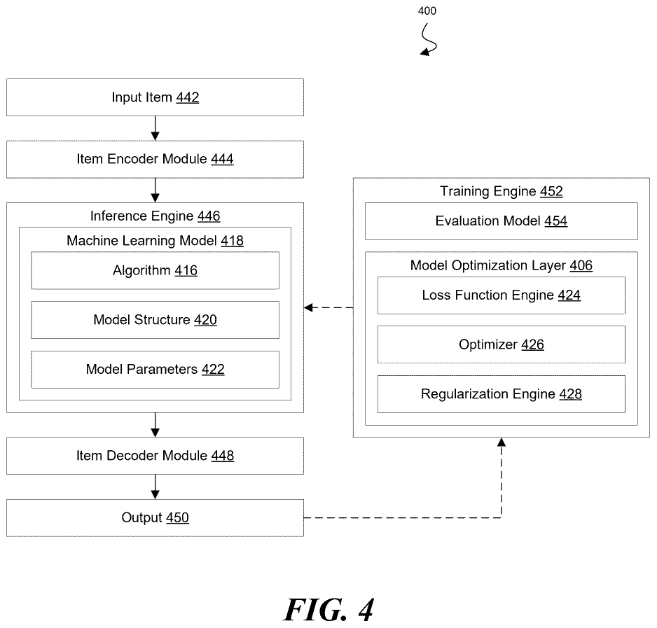

FIG. 4 illustrates an example model implementation platform 400 implementing the model applied by the network 302 in accordance with some implementations of the present technology. According to various implementations, the model implementation platform 400 can include an inference engine 446 based on the machine learning model 418, algorithm 416, model structure 420, and model parameters 422. In additional or alternative implementations, the model implementation platform 400 can include a training engine 452 based on a separate evaluation model 454, the model optimization layer 406, loss function engine 424, optimizer 426, and regularization engine 428. In some embodiments, the model implementation platform 400 can include both the inference engine 446 and the training engine 452 in the workflow to train the machine learning model 418. In alternative or additional embodiments, the model implementation platform 400 can include the inference engine 446 without the training engine 452 in the workflow to make multiple model inferences without altering model parameters 422.

The algorithm 416 can be an organized set of computer-executable operations used to generate output data from a set of input data and can be described using pseudocode. The algorithm 416 can include program code that allows the computing resources to learn from new input data and create new/modified outputs based on what was learned. Once trained, the algorithm 416 can run at the computing resources to make predictions or decisions, improve computing resource performance, or perform tasks. The algorithm 416 can be trained using supervised learning, unsupervised learning, semi-supervised learning, self-supervised learning, reinforcement learning, and/or federated learning.

Using supervised learning, the algorithm 416 can be trained to learn patterns (e.g., match input data to output data) based on labeled training data. Supervised learning can involve classification and/or regression. Classification techniques involve teaching the algorithm 416 to identify a category of new observations based on training data and are used when the input data for the algorithm 416 is discrete. Said differently, when learning through classification techniques, the algorithm 416 receives training data labeled with categories and determines how features observed in the training data relate to the categories. Once trained, the algorithm 416 can categorize new data by analyzing the new data for features that map to the categories. Examples of classification techniques include boosting, decision tree learning, genetic programming, learning vector quantization, k-nearest neighbor (k-NN) algorithm, and statistical classification.

Federated learning (e.g., collaborative learning) can involve splitting the model training into one or more independent model training sessions, each model training session assigned an independent subset training dataset of the training dataset. The one or more independent model training sessions can each be configured to train a previous instance of the machine learning model 418 using the assigned independent subset training dataset for that model training session. After each model training session completes training the machine learning model 418, the algorithm 416 can consolidate the output model, or trained model, of each individual training session into a single output model that updates the machine learning model 418. In some implementations, federated learning enables individual model training sessions to operate in individual local environments without requiring exchange of data to other model training sessions or external entities. Accordingly, data visible within a first model training session is not inherently visible to other model training sessions.

Regression techniques involve estimating relationships between independent and dependent variables and are used when input data to the algorithm 416 is continuous. Regression techniques can be used to train the algorithm 416 to predict or forecast relationships between variables. To train the algorithm 416 using regression techniques, a user can select a regression method for estimating the parameters of the model. The user collects and labels training data that is input to the algorithm 416 such that the algorithm 416 is trained to understand the relationship between data features and the dependent variable(s). Once trained, the algorithm 416 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill in missing data for machine-learning-based pre-processing operations.

Under unsupervised learning, the algorithm 416 learns patterns from unlabeled training data. In particular, the algorithm 416 is trained to learn hidden patterns and insights of input data, which can be used for data exploration or for generating new data. Here, the algorithm 416 does not have a predefined output, unlike the labels output when the algorithm 416 is trained using supervised learning. Said another way, unsupervised learning is used to train the algorithm 416 to find an underlying structure of a set of data, group the data according to similarities, and represent that set of data in a compressed format. The platform can use unsupervised learning to identify patterns in input data.

The model implementation platform 400 can be configured to perform model inference on an input item 442 using the inference engine 446. For example, the model implementation platform 400 can supply the inference engine 446 with the input item 442 and generate an inference output item 450. In some embodiments, the model implementation platform 400 can supply the input item 442 to an item encoder module 444 to generate an encoded input item that is supplied to the inference engine 446 in lieu of the raw input item 442. In additional or alternative embodiments, the model implementation platform 400 can supply an immediate output item of the inference engine 446 to an item decoder module 448 to generate the output item 450. To clarify, in lieu of the immediate output item of the inference engine 446, the output item 450 can be generated as the decoded output of the item decoder module 448. In some embodiments, the model implementation platform 400 can include the item encoder module 444, item decoder module 448, and/or any combination thereof.

In some embodiments, the input item 442 provided to the model implementation platform 400 can include a character sequence (e.g., a text string of characters), an image, an audio signal, a set of vectors, general data objects (e.g., a class instance comprising internal attributes and/or properties), and/or any combination thereof. In other embodiments, the output item 450 generated from the model implementation platform 400 can include an image and/or a set of images. In additional or alternative embodiments, the output item 450 can include a character sequence such as information related to network coverage score, an audio signal, a set of vectors, general data objects, and/or any combination thereof.

In some embodiments, the item encoder module 444 and item decoder module 448 of the model implementation platform 400 can be a discrete set of algorithmic instructions to convert a source data item to a converted data item. For example, if the input item 442 was a multi-dimensional array of size m by n, the item encoder module 444 can be configured with a discrete set of algorithmic instructions to flatten the shape of the input item 442 array into a 1 by m×n shape array. In additional or alternative embodiments, the item encoder module 444 and item decoder module 448 can be individual neural network model layers separate from the machine learning model 418. In other embodiments, the item encoder module 444 and item decoder module 448 can be configured to ensure that the properties (e.g., array shape) of the converted data item adheres to a specified set of properties. For example, the item encoder module 444 can be configured to ensure that the input item 442 is converted into an acceptable input pattern for the machine learning model 418.

The model implementation platform 400 can be configured to perform model training on the output item 450 using the training engine 452. For example, the model implementation platform 400 can supply the training engine 452 with the output item 450 and generate a loss value using the loss function engine 424. The model implementation platform 400 can use the loss value generated from the loss function engine 424 to change and/or modify the model parameters 422 of the model used by the inference engine 446. In additional or alternative embodiments, the training engine 452 can include an evaluation model 454 that is separate from the machine learning model 418. In some embodiments, the evaluation model 454 can generate a loss compatible output item from the output item 450 that can be used to calculate the loss value using the loss function engine 424.

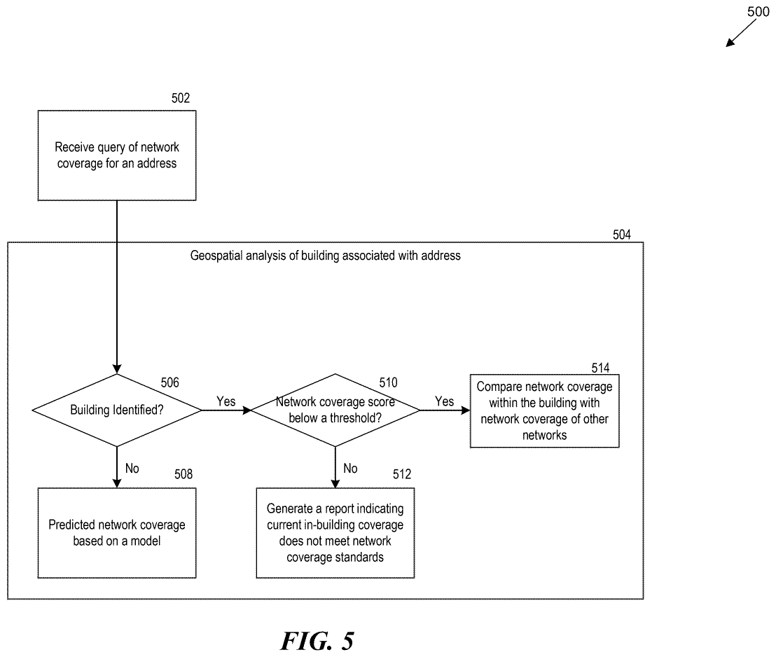

FIG. 5 is a drawing that illustrates an example process 500 performed by the network 302 upon receiving a query regarding in-building network coverage of a given location in accordance with aspects of the present technology. At 502, the network 302 receives a query requesting network coverage information for an address. In response to receiving the query, the network 302, at 504, performs geospatial analysis of a building associated with the address. The geospatial analysis can include methods as described in FIG. 3 as well as a series of steps as illustrated at 506, 508, and 514. At 506, the network 302 assesses whether a building exists in the address included in the query. If a building cannot be identified, at 508, the network 302, using a model, calculates predicted network coverage associated with the address. The predicted network coverage can be based on historical network coverage data observed in nearby locations.

If a building can be identified, the network 302 proceeds to 510. The network 302 performs geospatial analysis of the building according to the methods described in FIG. 3. Upon determining that a network coverage score of the building is below a threshold, the network 302 at 512 generates a report indicating that current in-building coverage does not meet network coverage standards. Upon determining that the network coverage score meets or is above the threshold, the network 302 at 514 can be configured to compare network coverage with that of other networks within the building to gauge the network 302's performance against its competitors.

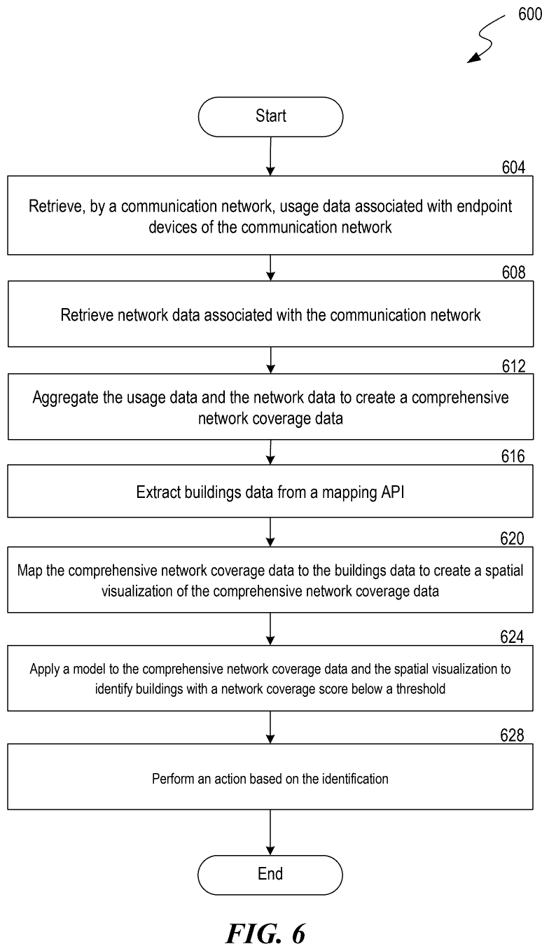

FIG. 6 is a flow diagram that illustrates an example process 600 in accordance with aspects of the present technology. In some implementations, the process 600 is performed by a network, such as the network 302 as described in more detail with reference to FIG. 3. In some implementations, the process is performed by a computer system, e.g., example computer system 800 illustrated and described in more detail with reference to FIG. 8. Other implementations can include different and/or additional steps or can perform the steps in different orders.

At 604, a communication network retrieves usage data associated with endpoint devices of the communication network from an external database. The usage data includes multiple datapoints each representing usage metrics captured by the endpoint devices. The usage data can include latency, throughput, packet loss, signal strength, signal quality, connection speed, and/or Quality of Service (QoS) score captured by the endpoint devices. The usage data can be captured and stored by data analysis platforms such as Ookla or Umlaut. In some implementations, the usage data includes multiple datapoints captured by endpoint devices associated with multiple communication networks. In other implementations, the usage data includes datapoints captured by endpoints associated only with the communication network.

At 608, the communication network retrieves network data associated with the communication network from an internal database. The network data associated with the communication network can include network capacity, network density, network utilization, network availability, network topology data, and/or traffic analysis.

At 612, the communication network aggregates the usage data and the network data to create a comprehensive network coverage data. As explained above with regard to FIG. 3, the aggregation can be performed by identifying features common to the usage data and the network data, such as location information identifying latitude and longitude associated with a datapoint. The usage data and the network data can subsequently be aligned using the common identifying feature and combined into a single dataset. The aggregation can also be performed using database joins, data warehousing, or ETL procedures. In some implementations, the network 302 performs data cleaning on the comprehensive network coverage data to remove duplicate entries, address missing datapoints via imputations or removal of incomplete records, convert the data into a standardized format, and/or remove outliers or erroneous entries.

At 616, the communication network extracts building data from a mapping API. Examples of mapping API can include Google Maps API, OpenStreetMap API, Mapbox API, and Here API. After obtaining API access and retrieving buildings data in response to an API request, the communication network can employ visualization tools to visualize the buildings data.

At 620, the communication network maps the comprehensive network coverage data to the buildings data to aggregate the data and create a spatial visualization of the comprehensive network coverage data. Spatial aggregation of the buildings data includes associating datapoints of the network coverage data with corresponding buildings of the buildings data. In some implementations, the communication network utilizes feature engineering to capture additional metrics that are relevant for spatial aggregation of the buildings data. In other implementations, additional layers of data are aggregated along with the usage data and the network data. The additional layers can include data of businesses and locations of businesses extracted from Dun and Bradstreet API, which can be utilized along with the usage data and the network data to identify correlations between the network coverage data and the locations of businesses.

At 624, based on the comprehensive network coverage data and the spatial visualization, the communication network applies a model to evaluate network coverage of buildings by assigning network coverage scores to identified buildings. The model can be further utilized to identify buildings with a network coverage score below a threshold. Various factors may be considered when calculating the network coverage scores, such as signal quality, signal strength, throughput, and history of performance bottlenecks reported.

At 628, the communication network performs an action based on the identification. The action can be an action pre-configured by the communication network to be performed in response to identifying a building with a network coverage score below a threshold. The action can also include generating a report of the network coverage of the identified buildings, wherein the report includes usage data and network data of multiple datapoints captured within the buildings.

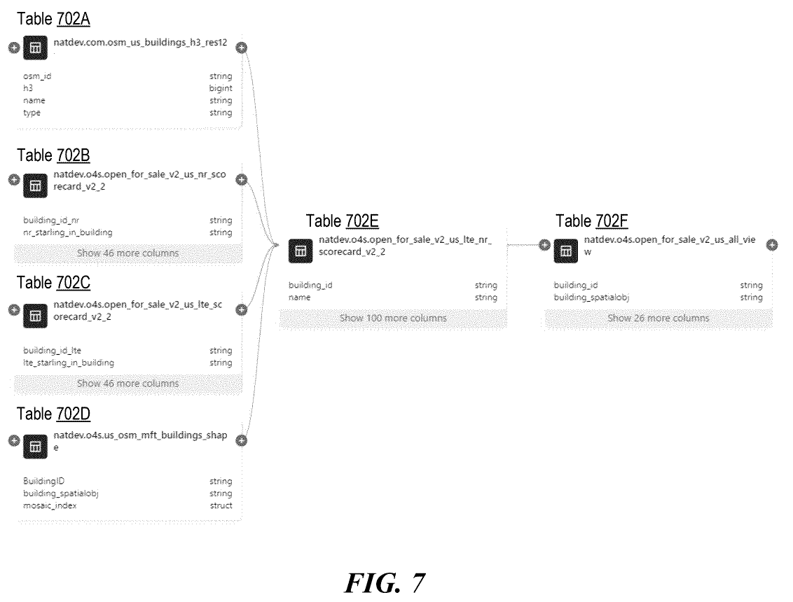

FIG. 7 is a diagram that illustrates data tables aggregated by the network 302 in accordance with aspects of the present technology. Tables 702A-702F demonstrate scorecards that include various network performance metrics such as network coverage score, network capacity score, network quality, and network readiness. The scorecards also include information extracted and aggregated from the buildings data, such as building identification information, building type, and building name. The scorecards also include usage data received from data analysis platforms, the usage data including download and upload speeds, reference signal received power (RSRP), and signal-to-interference-plus-noise ratio (SINR). In some implementations, relationships between buildings and subdivisions of buildings can be illustrated using lines that connect the corresponding scorecards.

### Computer System

FIG. 8 is a block diagram that illustrates an example of a computer system 800 in which at least some operations described herein can be implemented. As shown, the computer system 800 can include: one or more processors 802, main memory 806, non-volatile memory 810, a network interface device 812, video display device 818, an input/output device 820, a control device 822 (e.g., keyboard and pointing device), a drive unit 824 that includes a machine-readable (storage) medium 826, and a signal generation device 830 that are communicatively connected to a bus 816. The bus 816 represents one or more physical buses and/or point-to-point connections that are connected by appropriate bridges, adapters, or controllers. Various common components (e.g., cache memory) are omitted from FIG. 8 for brevity. Instead, the computer system 800 is intended to illustrate a hardware device on which components illustrated or described relative to the examples of the figures and any other components described in this specification can be implemented.

The computer system 800 can take any suitable physical form. For example, the computing system 800 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 800. In some implementations, the computer system 800 can be an embedded computer system, a system-on-chip (SOC), a single-board computer (SBC) system or a distributed system such as a mesh of computer systems or include one or more cloud components in one or more networks. Where appropriate, one or more computer systems 800 can perform operations in real time, near real time, or in batch mode.

The network interface device 812 enables the computing system 800 to mediate data in a network 814 with an entity that is external to the computing system 800 through any communication protocol supported by the computing system 800 and the external entity. Examples of the network interface device 812 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 806, non-volatile memory 810, machine-readable (storage) medium 826) can be local, remote, or distributed. Although shown as a single medium, the machine-readable (storage) medium 826 can include multiple media (e.g., a centralized/distributed database and/or associated caches and servers) that store one or more sets of instructions 828. The machine-readable (storage) medium 826 can include any medium that is capable of storing, encoding, or carrying a set of instructions for execution by the computing system 800. The machine-readable (storage) medium 826 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 810, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in computing device(s). When read and executed by the processor 802, the instruction(s) cause the computing system 800 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A computer-implemented method for telecommunication, comprising:
retrieving, by a communication network, usage data associated with endpoint devices of the communication network,
wherein the usage data includes multiple datapoints each representing usage metrics captured by the endpoint devices;
retrieving, by the communication network, network data associated with the communication network;
aggregating the usage data and the network data to create a comprehensive network coverage data;
extracting, by the communication network, buildings data from a mapping application programming interface (API);
mapping the comprehensive network coverage data to the buildings data to create a spatial visualization of the comprehensive network coverage data;
applying a model to the comprehensive network coverage data and the spatial visualization to identify buildings with a network coverage score below a threshold; and
performing an action based on the identification.

2. The computer-implemented method of claim 1, wherein performing the action based on the identification further comprises:
generating a report of the network coverage data of the buildings with the network coverage score below the threshold,
wherein the report includes usage data of multiple datapoints captured within the buildings.

3. The computer-implemented method of claim 1, wherein the usage data includes latency, throughput, packet loss, signal strength, signal quality, connection speed, and/or Quality of Service (QoS) score captured by the endpoint devices.

4. The computer-implemented method of claim 1, wherein the usage data includes multiple datapoints captured by endpoint devices associated with multiple communication networks.

5. The computer-implemented method of claim 1, wherein the network data associated with the communication network includes network capacity, network density, network utilization, network availability, network topology data, and/or traffic analysis.

6. The computer-implemented method of claim 1, wherein the model is a rule-based model or a machine learning (ML) model.

7. The computer-implemented method of claim 1, wherein the spatial visualization of the comprehensive network coverage data includes multiple polygons each representing a building, and wherein each polygon is associated with multiple datapoints captured by the endpoint devices within the building.

8. The computer-implemented method of claim 7, further comprising:
generating, within each polygon, subdivisions of datapoints, wherein each subdivision includes datapoints with common usage metrics.

9. The computer-implemented method of claim 1, wherein the usage data is anonymized.

10. A non-transitory, computer-readable storage medium comprising instructions recorded thereon, wherein the instructions, when executed by at least one data processor of a system, cause the system to:
retrieve usage data associated with endpoint devices of a communication network,
wherein the usage data includes multiple datapoints each representing usage metrics captured by the endpoint devices;
retrieve network data associated with the communication network;
aggregate the usage data and the network data to create a comprehensive network coverage data;
extract buildings data from a mapping application programming interface (API);
map the comprehensive network coverage data to the buildings data to create a spatial visualization of the comprehensive network coverage data;
apply a model to the comprehensive network coverage data and the spatial visualization to identify buildings with a network coverage score below a threshold; and
perform an action based on the identification.

11. The non-transitory, computer-readable storage medium of claim 10, wherein the instructions further cause the system to:
generate a report of the network coverage data of the buildings with the network coverage score below the threshold,
wherein the report includes usage data of multiple datapoints captured within the buildings.

12. The non-transitory, computer-readable storage medium of claim 10, wherein the usage data includes latency, throughput, packet loss, signal strength, signal quality, connection speed, and/or Quality of Service (QoS) score captured by the endpoint devices.

13. The non-transitory, computer-readable storage medium of claim 10, wherein the usage data includes multiple datapoints captured by endpoint devices associated with multiple communication networks.

14. The non-transitory, computer-readable storage medium of claim 10, wherein the network data associated with the communication network includes network capacity, network density, network utilization, network availability, network topology data, and/or traffic analysis.

15. The non-transitory, computer-readable storage medium of claim 10, wherein the model is a rule-based model or a machine learning (ML) model.

16. The non-transitory, computer-readable storage medium of claim 10, wherein the spatial visualization of the comprehensive network coverage data includes multiple polygons each representing a building, and wherein each polygon is associated with multiple datapoints captured by the endpoint devices within the building.

17. The non-transitory, computer-readable storage medium of claim 10, wherein the instructions further cause the system to:
generate, within each polygon, subdivisions of datapoints, wherein each subdivision includes datapoints with common usage metrics.

18. A system comprising:
at least one hardware processor; and
at least one non-transitory memory storing instructions, which, when executed by the at least one hardware processor, cause the system to:
retrieve usage data associated with endpoint devices of a communication network,
wherein the usage data includes multiple datapoints each representing usage metrics captured by the endpoint devices;
retrieve network data associated with the communication network;
aggregate the usage data and the network data to create a comprehensive network coverage data;
extract buildings data from a mapping application programming interface (API);
map the comprehensive network coverage data to the buildings data to create a spatial visualization of the comprehensive network coverage data;
apply a model to the comprehensive network coverage data and the spatial visualization to identify buildings with a network coverage score below a threshold; and
perform an action based on the identification.

19. The system of claim 18, wherein the instructions further cause the system to:
generate a report of the network coverage data of the buildings with the network coverage score below the threshold,
wherein the report includes usage data of multiple datapoints captured within the buildings.

20. The system of claim 18, wherein the instructions further cause the system to:
generate, within each polygon, subdivisions of datapoints, wherein each subdivision includes datapoints with common usage metrics.
